(19) United States
(12) Patent Application Publication
(10) Pub. No.: US 2019/0009745 A1
(43) Pub. Date: Jan. 10, 2019

(54) AIR BAG APPARATUS

(71) Applicant: HONDA MOTOR CO., LTD., Tokyo (JP)

(72) Inventors: Kazuki Hikida, Wako-shi (JP); Yuji Ishizuka, Wako-shi (JP); Ryosuke Seki, Wako-shi (JP); Tatsuya Narikawa, Wako-shi (JP); Yuichi Mashiko, Wako-shi (JP); Hitoshi Higuchi, Wako-shi (JP)

(21) Appl. No.: 16/018,092

(22) Filed: Jun. 26, 2018

(30) Foreign Application Priority Data
Jul. 10, 2017 (JP) 2017-134388

(51) Int. Cl. B60R 21/233; B60R 21/205

(52) U.S. Cl. CPC B60R 21/233; B60R 21/237; B60R 21/205

(57) ABSTRACT

An air bag apparatus includes: an inflator that generates a gas when an impact is input; a main bag part that is supplied with the gas from the inflator and is inflated and expanded; a supplementary bag part that is connected to the main bag part and that is supplied with the gas via a plurality of communicating parts from an inside of the main bag part and is inflated and expanded; and a sheet member that is fixed to an inner surface of the supplementary bag part, that covers the entirety of the plurality of communicating parts, and that is formed to be capable of approaching and being separated from a portion between the plurality of communicating parts in the inner surface of the supplementary bag part.

### CROSS-REFERENCE TO RELATED APPLICATION

Priority is claimed on Japanese Patent Application No. 2017-134388, filed on Jul. 10, 2017, the contents of which are incorporated herein by reference.

### BACKGROUND

### Field of the Invention

The present invention relates to an air bag apparatus.

### Background

In the related art, as one of air bag apparatuses, an air bag apparatus is known which includes a main bag part and a supplementary bag part that is connected to the main bag part and that is inflated and expanded by a gas which is supplied from the main bag part (for example, refer to Japanese Patent Application, Publication No. 2016-153262 and Japanese Patent Application, Publication No. 2016-040160). This sort of air bag apparatus is used, for example, as one in use for a passenger seat and has a configuration so as to receive a passenger by the main bag part at the time of front collision of a vehicle and receive the passenger by the supplementary bag part, for example, at the time of oblique collision.

The air bag apparatus having the configuration described above is constituted so as to maintain the internal pressure of the supplementary bag part that is inflated and expanded and accurately receive the occupant when being operated. For example, the air bag apparatus described in Japanese Patent Application, Publication No. 2016-153262 includes a main bag that is inflated and expanded at a vehicle frontward position of a seat, a center bag that is provided at an inner side in a vehicle width direction of the main bag and that is inflated and expanded to protrude in a more vehicle rearward direction than the main bag, a partition wall part that separates the main bag and the center bag, and an internal pressure maintaining mechanism that is provided on the partition wall part, that makes it possible for the gas to pass from the main bag to the center bag, and that makes it impossible for the gas to pass from the center bag to the main bag. The internal pressure maintaining mechanism includes a hole part that is formed on the partition wall part and a patch part which is connected to the partition wall part to cover the hole part from the center bag part side and at least part of which can be separated from wall parts. The patch part is provided so as to correspond to each hole part and covers the entire hole part from the center bag part side. At least part of the patch part is connected to the partition wall part by sewing or the like in a separable manner from the partition wall part.

The air bag apparatus according to Japanese Patent Application, Publication No. 2016-040160 includes a main bag part and a supplementary bag part that is inflated at one lateral surface side in a right-to-left direction of the main bag part, wherein the apparatus has a configuration in which an oblique collision restraint section in the supplementary bag part becomes a high-pressure part that has a higher inner pressure than the main bag part, and the inflation is completed. A low-pressure part that is in communication with the main bag part and that is partitioned from the high-pressure part by a partition wall to have a lower inner pressure than the oblique collision restraint section is provided at a frontward side of the oblique collision restraint section in the supplementary bag part when the inflation is completed. Further, a non-return valve as an expansion gas supply mechanism that allows a flow of an inflation gas from the low-pressure part side to the high-pressure part side and that regulates a flow of the inflation gas from the high-pressure part side to the low-pressure part side is provided on the partition wall. The non-return valve is formed by joining a flap valve having a sheet shape to circumferential edges of four communicating holes that open in proximity to upper, lower, right, and left parts in the partition wall. The flap valve is provided so as to provide a joint part that sews front and rear edges of the flap valve along the vertical direction and that sews the center region of the flap valve in a cross shape with respect to the partition wall at the circumferential edge of the communicating hole.

### SUMMARY

However, in the air bag apparatus described in Japanese Patent Application, Publication No. 2016-153262, a patch part is provided one by one so as to correspond to each hole part. Therefore, when the inner pressure of the center bag is increased, the patch part is easily displaced, and the end edge of the patch part easily enters the hole part. Thereby, there is a possibility that a gap may be generated at the hole part, and the gas may flow back to the main bag. In the air bag apparatus described in Japanese Patent Application, Publication No. 2016-040160, the flap valve is sewn to a part between the plurality of communicating holes in the partition wall. Therefore, when the gas flows into the high-pressure part from the low-pressure part, there is a possibility that the flap valve may not be sufficiently separated from the partition wall, and the gas may not be smoothly supplied to the high-pressure part. Accordingly, in the air bag apparatus of the related art, there is a problem that, at the time of inflation and expansion of the supplementary bag part, it is difficult to smoothly supply a gas to the supplementary bag part and to promptly inflate and expand the supplementary bag part, and it is difficult to reliably regulate the flowback of the gas from the supplementary bag part to the main bag part and to maintain the inner pressure of the supplementary bag part that is inflated and expanded.

An aspect of the present invention provides an air bag apparatus capable of promptly inflating and expanding a supplementary bag part and capable of maintaining the inner pressure of the supplementary bag part that is inflated and expanded.

An air bag apparatus according to an aspect of the present invention includes: an inflator that generates a gas when an impact is input; a main bag part that is supplied with the gas from the inflator and is inflated and expanded; a supplementary bag part that is connected to the main bag part and that is supplied with the gas via a plurality of communicating parts from an inside of the main bag part and is inflated and expanded; and a sheet member that is fixed to an inner surface of the supplementary bag part, that covers the entirety of the plurality of communicating parts, and that is formed to be capable of approaching and being separated from a portion between the plurality of communicating parts in the inner surface of the supplementary bag part.

According to the present configuration, since the sheet member covers the entirety of the plurality of communicating parts, when the inner pressure of the supplementary bag part is increased, the sheet member is pulled toward the main bag part side at each of the plurality of communicating parts. Thereby, since portions of the sheet member that correspond to portions between the adjacent communicating parts are pulled in an opposite direction to each other, it is possible to prevent the sheet member from being displaced along the inner surface of the supplementary bag part and entering the communicating part. Accordingly, it is possible to prevent a gap from being generated at the communicating part and to prevent the gas from flowing back to the main bag part.

Further, since the sheet member is capable of approaching and being separated from the portion between the plurality of communicating parts in the inner surface of the supplementary bag part, when the gas flows into the supplementary bag part from the main bag part, a gap between the inner surface of the supplementary bag part and the sheet member is formed to be large compared to a configuration in which the sheet member is sewn to a part between the plurality of communicating parts in the inner surface of the supplementary bag part as in the related art. Thereby, it is possible to smoothly supply the gas to the supplementary bag part.

Accordingly, it is possible to promptly inflate and expand the supplementary bag part, and it is possible to maintain the inner pressure of the supplementary bag part that is inflated and expanded.

The air bag apparatus described above may include a pair of fixation parts to which the sheet member and an inner surface of the supplementary bag part are fixed, wherein the plurality of communicating parts may be provided between the pair of fixation parts in the inner surface of the supplementary bag part, and a minimal distance between the pair of fixation parts in the sheet member may be larger than a spacing between the pair of fixation parts in the inner surface of the supplementary bag part.

According to the present configuration, the sheet member is arranged between the pair of fixation parts in a slack state. Thereby, when the gas flows into the supplementary bag part from the main bag part, it is possible to provide a gap between the inner surface of the supplementary bag part and the sheet member so as to be further large. Accordingly, it is possible to further smoothly supply the gas to the supplementary bag part.

Further, as described above, when the inner pressure of the supplementary bag part is increased, since the displacement of the sheet member along the inner surface of the supplementary bag part is prevented, even when the degree of freedom of the movement of the sheet member is increased by the sheet member being slack, the entering of the sheet member into the communicating part is prevented. Accordingly, it is possible to prevent a gap from being generated at the communicating part and prevent the gas from flowing back to the main bag part.

The air bag apparatus described above may include a pair of fixation parts to which the sheet member and an inner surface of the supplementary bag part are fixed, wherein the plurality of communicating parts may be provided side by side in a first direction, and each of the pair of fixation parts may be provided on each of both sides in a second direction that is orthogonal to the first direction of the communicating part.

In the present configuration, since each of the pair of fixation parts is provided on each of both sides in the second direction of the communicating part, the sheet member is pulled in the first direction that is orthogonal to the direction in which the pair of fixation parts is arranged side by side with respect to the inner surface of the supplementary bag part when the gas flows back. Further, since the plurality of communicating parts are arranged side by side in the first direction, the number of each of communicating parts close to each of end edges in the first direction of the sheet member is one. Thereby, even when the sheet member is pulled and displaced in the first direction at the time of the gas flowing back, each of the end edge in the first direction of the sheet member merely approaches one of the communicating parts. Accordingly, compared to a configuration in which each of the pair of fixation parts is provided on each of both sides in the first direction of the communicating part, the end edge of the sheet member does not easily enter the communicating part, and it is possible to prevent a gap from being formed at the communicating part.

In the air bag apparatus described above, the pair of fixation parts may extend along the first direction, and a size in the first direction of the pair of fixation parts may be larger than a spacing between the pair of fixation parts.

In a case where a predetermined region having a rectangular shape in the inner surface of the supplementary bag part is covered by the sheet member, the sheet member is fixed along a long side of the predetermined region, and thereby, it is possible to make it difficult for the sheet member to be displaced compared to a case where the sheet member is fixed along a short side of the predetermined region. According to the present configuration, since the pair of fixation parts extends along the first direction in which the plurality of communicating parts are arranged side by side, and the size in the first direction of the pair of fixation parts is larger than the spacing between the pair of fixation parts, the sheet member becomes a state of being fixed along the long side of the region described above having a rectangular shape. Thereby, it is possible to make it difficult for the sheet member to be displaced compared to a case where the pair of fixation parts extends along the first direction, and the size in the first direction of the pair of fixation parts is smaller than the spacing between the pair of fixation parts. Accordingly, it is possible to further reliably prevent the end edge of the sheet member from entering the communicating part and prevent a gap from being formed at the communicating part.

According to an aspect of the present invention, it is possible to provide an air bag apparatus capable of promptly inflating and expanding the supplementary bag part and capable of maintaining the inner pressure of the supplementary bag part that is inflated and expanded.

### BRIEF DESCRIPTION OF THE DRAWINGS

FIG. 1 is a plan view of a front part inside a vehicle room of a vehicle of an embodiment.

FIG. 2 is a view showing a state where an air bag apparatus of the embodiment is operated and is a side view showing the front part inside the vehicle room of the vehicle.

FIG. 3 is a view showing a state where the air bag apparatus of the embodiment is operated and is a plan view showing the front part inside the vehicle room of the vehicle.

FIG. 4 is a view showing a state where the air bag apparatus of the embodiment is operated and is a front view showing the front part inside the vehicle room of the vehicle.

FIG. 5 is a cross-sectional view in a V-V line of FIG. 2.

FIG. 6 is a view showing an inner surface of a supplementary bag part and is an arrow view in a VI direction of FIG. 5.

FIG. 7 is a view showing the inner surface of the supplementary bag part and is an arrow view in the VI direction of FIG. 5.

FIG. 8 is a cross-sectional view in a VIII-VIII line of FIG. 7.

FIG. 9 is a cross-sectional view in the VIII-VIII line of FIG. 7.

### DESCRIPTION OF THE EMBODIMENTS

Hereinafter, an embodiment of the present invention will be described with reference to the drawings. In the following description, the same reference numeral is given to configurations having the same or similar function. There may be cases in which redundant description of the configurations is omitted.

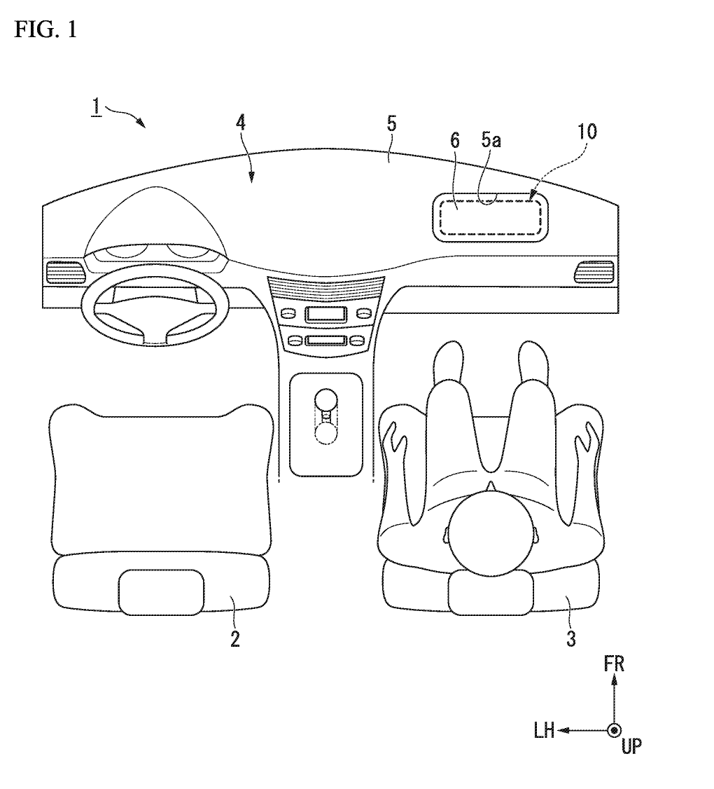

FIG. 1 is a plan view of a front part inside a vehicle room of a vehicle of an embodiment.

As shown in FIG. 1, a vehicle 1 includes a driver seat 2 and a passenger seat 3 that are provided in a vehicle room, an instrument panel 4 that is provided in front of the driver seat 2 and the passenger seat 3, and an air bag apparatus 10 that is provided on the instrument panel 4. Front-to-rear, vertical, and right-to-left directions in the following description are the same as front-to-rear, vertical, and right-to-left directions in the vehicle if there is no particular description. In the drawings, an arrow UP indicates an upward direction, an arrow FR indicates a frontward direction, and an arrow LH indicates a leftward direction.

The instrument panel 4 has a panel main body 5 and a cap body 6. An air bag opening 5a that penetrates through the panel main body 5 is formed on a part that is located at a frontward position of the passenger seat 3 of the panel main body 5. The air bag opening 5a is an opening for providing the air bag apparatus 10 on the instrument panel 4. The cap body 6 is fitted to the air bag opening 5a of the panel main body 5.

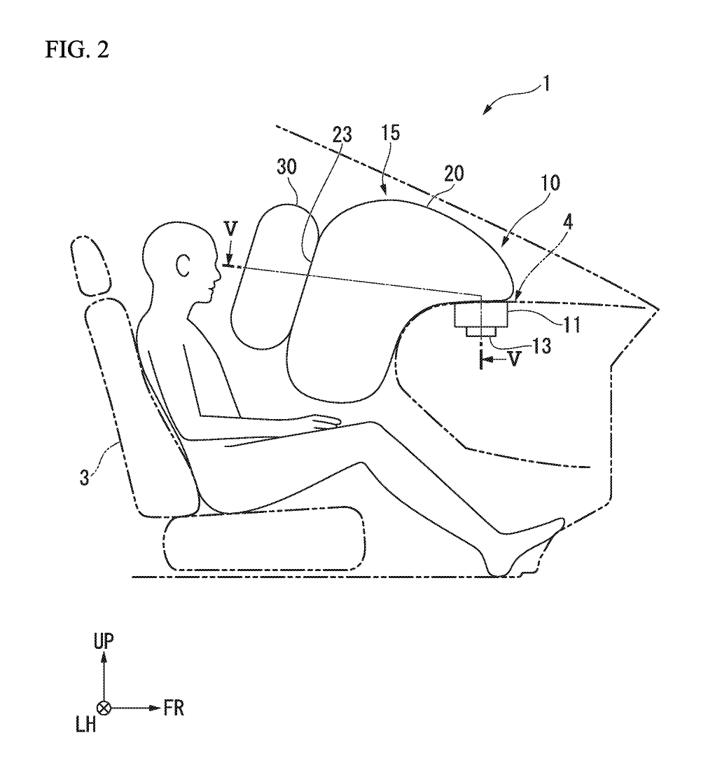

FIG. 2 is a view showing a state where the air bag apparatus of the embodiment is operated and is a side view showing the front part inside the vehicle room of the vehicle.

As shown in FIG. 2, the air bag apparatus 10 includes a retainer 11, an inflator 13, and an air bag 15. The retainer 11 accommodates and supports the air bag 15.

The retainer 11 is formed in a box shape that opens upward. In normal times, the air bag 15 is accommodated in the retainer 11 in a state of being folded, and an upper opening of the retainer 11 is closed by the cap body 6 (refer to FIG. 1). The inflator 13 generates a high-pressure gas when an impact is input to the vehicle 1.

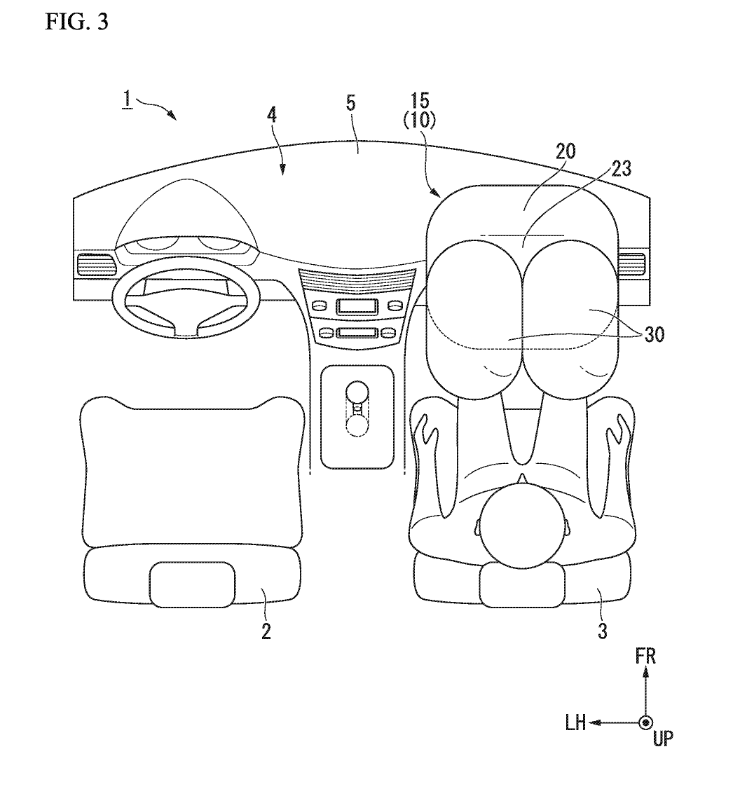

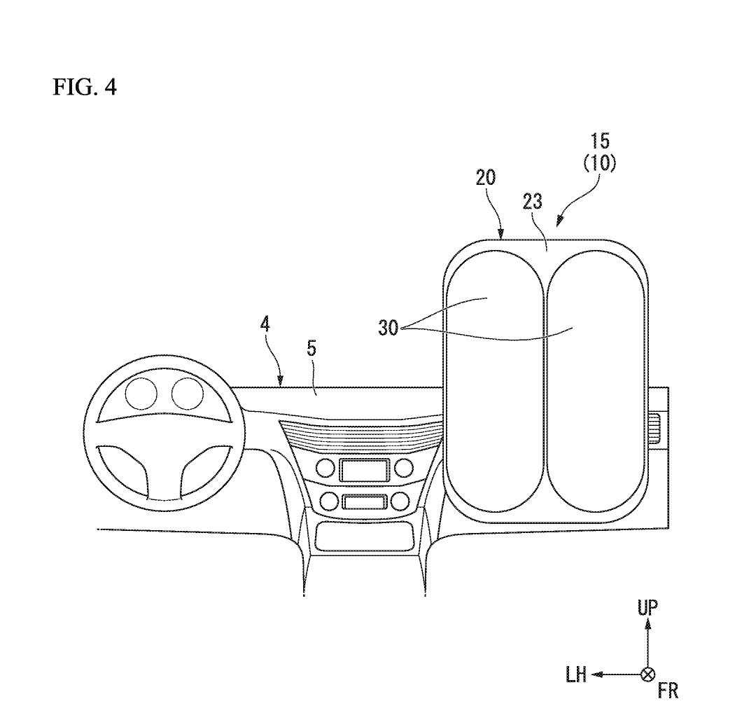

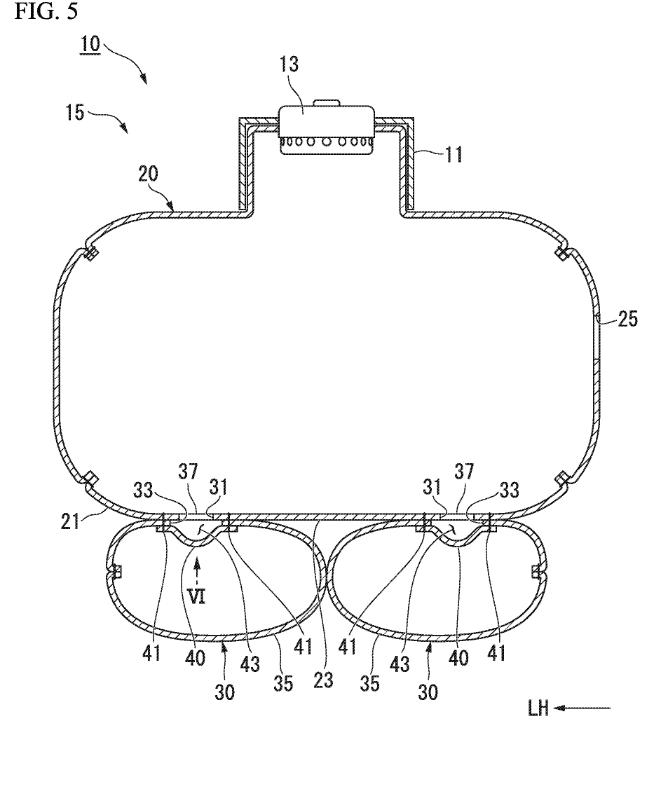

FIG. 3 is a view showing a state where the air bag apparatus of the embodiment is operated and is a plan view showing the front part inside the vehicle room of the vehicle. FIG. 4 is a view showing a state where the air bag apparatus of the embodiment is operated and is a front view showing the front part inside the vehicle room of the vehicle. FIG. 5 is a cross-sectional view in a V-V line of FIG. 2.

As shown in FIGS. 2 to 5, the air bag 15 is inflated by the gas of the inflator 13 when the air bag apparatus 10 is operated and is expanded to a space between an occupant who is seated on the passenger seat 3 and the instrument panel 4. The air bag 15 includes a main bag part 20, a pair of supplementary bag parts 30 that is connected to the main bag part 20, a sheet member 40 that is provided inside the supplementary bag part 30, and a fixation part 41 to which the supplementary bag part 30 and the sheet member 40 are fixed.

As shown in FIG. 5, the main bag part 20 is supplied with the gas from the inflator 13 and is inflated and expanded. The main bag part 20 is a part into which the gas from the inflator 13 flows first. The main bag part 20 is formed in a bag shape, for example, by seaming a plurality of foundation cloths 21. The main bag part 20 includes a rear surface 23 that faces an upper body of the occupant (refer to FIG. 2) who is seated on the passenger seat 3 in a state where the main bag part 20 is inflated and expanded. The main bag part 20 receives the upper body of the occupant who is seated on the passenger seat 3 at the time of front collision of the vehicle 1. A vent hole 25 is formed on the foundation cloth 21 that forms the main bag part 20. A vent hole 25 opens, for example, at one side (in the example of the drawing, at a right side) in a right-to-left direction. The vent hole 25 is provided in order to discharge the gas to the outside at the time of inflation and expansion of the main bag part 20.

As shown in FIG. 3 and FIG. 4, the pair of supplementary bag parts 30 is arranged side by side in the right-to-left direction and is connected to the rear surface 23 of the main bag part 20. The pair of supplementary bag parts 30 is provided so as to be inflated and expanded to a space between the main bag part 20 and a head part of an occupant who is seated on the passenger seat 3. More specifically, the pair of supplementary bag parts 30 is provided so as to be capable of receiving the head part of the occupant who is seated on the passenger seat 3 between the pair of supplementary bag parts 30 at the time of front collision of the vehicle 1. Further, the pair of supplementary bag parts 30 is provided so as to be capable of receiving the head part of the occupant who is seated on the passenger seat 3 by at least any one of the supplementary bag parts 30 at the time of oblique collision of the vehicle 1.

As shown in FIG. 4, each of the supplementary bag parts 30 is formed in an oval shape having a long axis that extends in the vertical direction when seen from the front-to-rear direction. The supplementary bag part 30 that is provided on the left side is provided so as to overlap with a left half portion of the main bag part 20 when seen from the front-to-rear direction. The supplementary bag part 30 that is provided on the right side is provided so as to overlap with a right half portion of the main bag part 20 when seen from the front-to-rear direction. Since the pair of supplementary bag parts 30 is formed symmetrically in the right-to-left direction, the supplementary bag part 30 that is provided on the left side is described in the following description unless specifically stated.

As shown in FIG. 5, the supplementary bag part 30 is supplied with the gas via a communicating part 31 from the inside of the main bag part 20 and is inflated and expanded. The supplementary bag part 30 is formed of a bag body 35 on which an opening part 33 is formed and a partition wall part 37 that is part of the foundation cloth 21 which forms the main bag part 20 and that closes the opening part 33. The bag body 35 is formed in a bag shape, for example, by duplicating one foundation cloth to be overlapped and seaming an outer circumferential edge part.

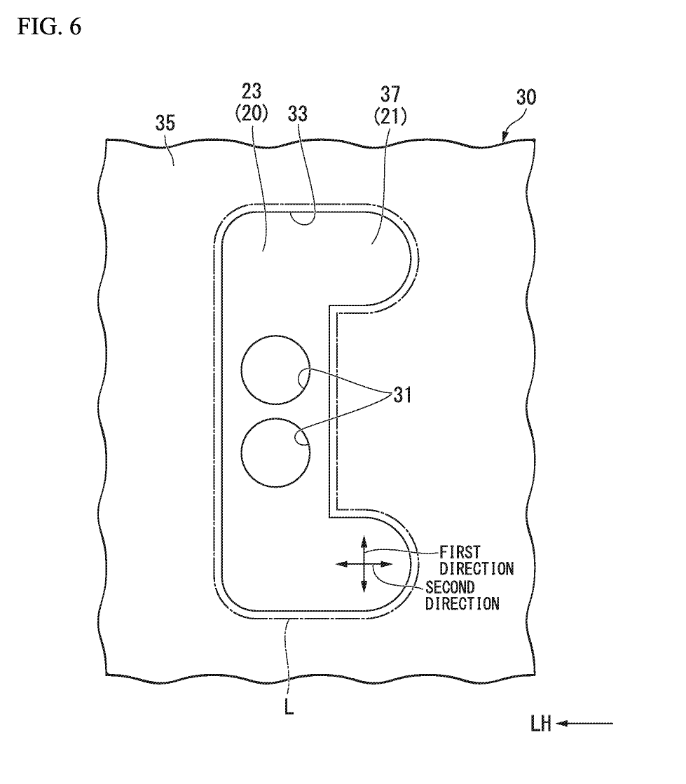

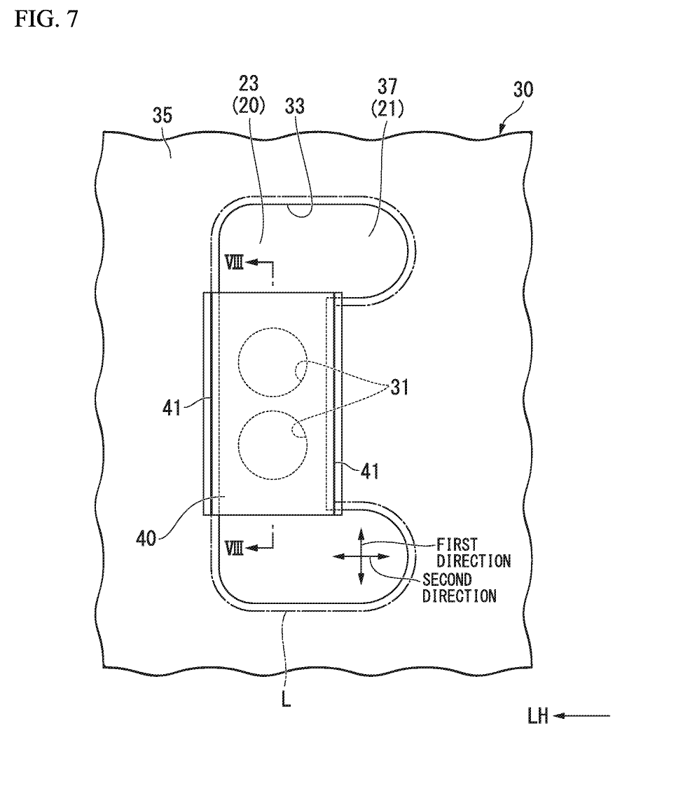

FIG. 6 and FIG. 7 are views showing an inner surface of the supplementary bag part and are arrow views in a VI direction of FIG. 5.

FIG. 6 shows a state in which the sheet member is not attached.

As shown in FIG. 5 and FIG. 6, the opening part 33 is formed on the bag body 35. The opening part 33 is formed on a front part of the bag body 35. The opening part 33 is formed in a U shape such that the opening part 33 extends in the vertical direction when seen from the front-to-rear direction, and both upper and lower end portions of the opening part 33 extend toward the rightward direction. The bag body 35 is arranged at a rearward position of the main bag part 20 such that the opening part 33 is closed by the rear surface 23 of the main bag part 20. Thereby, part of the inner surface of the supplementary bag part 30 is constituted of the rear surface 23 of the main bag part 20. A portion which is part of the foundation cloth 21 that forms the main bag part 20 and which closes the opening part 33 becomes the partition wall part 37 that separates the inside of the supplementary bag part 30 and the inside of the main bag part 20. The bag body 35 is seamed to the foundation cloth 21 that forms the main bag part 20 in a seam line L that is provided on the entire circumference along the opening edge of the opening part 33. A portion (portion that is located on the right side of the opening part 33) which is part of the seam line L and which is opposed in the right-to-left direction to the supplementary bag part 30 that is provided on the right side is recessed to the leftward direction when seen from the front-to-rear direction so as to be separated from the supplementary bag part 30 that is provided on the right side.

A plurality of (in the present embodiment, a pair of) communicating parts 31 are formed on the partition wall part 37. The communicating part 31 is a penetration hole that allows the inside of the supplementary bag part 30 and the inside of the main bag part 20 to be in communication with each other. In the present embodiment, the communicating part 31 is formed in a circular hole shape. A first direction and a second direction in a direction along the inner surface of the partition wall part 37 of the supplementary bag part 30 are defined as described below. The first direction is a direction that coincides with the vertical direction when seen from the front-to-rear direction. The second direction is a direction that is orthogonal to the first direction and is a direction that coincides with the right-to-left direction when seen from the front-to-rear direction. The plurality of communicating parts 31 are provided side by side in the first direction at a middle portion in the first direction of the partition wall part 37.

As shown in FIG. 7, the sheet member 40 restricts the flow of the gas from the inside of the supplementary bag part 30 to the inside of the main bag part 20. The sheet member 40 is formed of, for example, the same material as the foundation cloth 21 that forms the main bag part 20. The sheet member 40 is formed in a rectangular shape in a plan view. The sheet member 40 covers the entirety of the plurality of communicating parts 31 when seen from a direction that is orthogonal to the first direction and the second direction. The sheet member 40 is fixed to an inner surface of the supplementary bag part 30 at the pair of fixation parts 41. Each of the pair of fixation parts 41 is provided on each of both sides in the second direction of the pair of communicating parts 31. The sheet member 40 is seamed together with the foundation cloth 21 that forms the main bag part 20 and the bag body 35 of the supplementary bag part 30 on the seam line L. That is, the pair of fixation parts 41 is formed on the seam line L. Each fixation part 41 extends linearly along the first direction. The sizes in the first direction of the pair of fixation parts 41 are similar to each other and are larger than the spacing between the pair of fixation parts 41.

As shown in FIG. 5, the sheet member 40 is provided in a slack state with respect to the inner surface of the supplementary bag part 30. Specifically, the minimal distance between the pair of fixation parts 41 in the sheet member 40 is larger than the spacing between the pair of fixation parts 41 in the inner surface of the supplementary bag part 30. Thereby, the sheet member 40 is formed to be capable of approaching and being separated from a portion between the plurality of communicating parts 31 in the inner surface of the supplementary bag part 30 in the direction that is orthogonal to the first direction and the second direction.

Hereinafter, an operation of the air bag apparatus 10 is described.

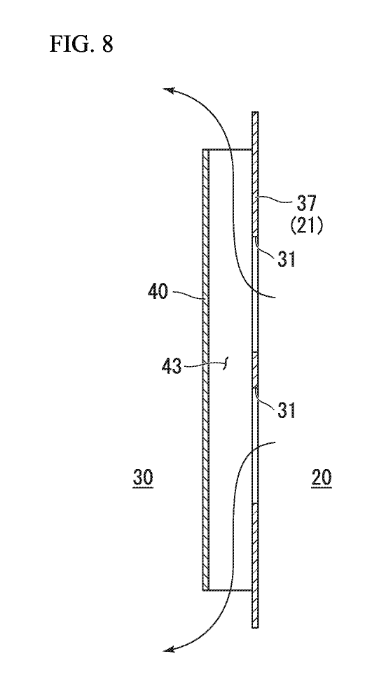

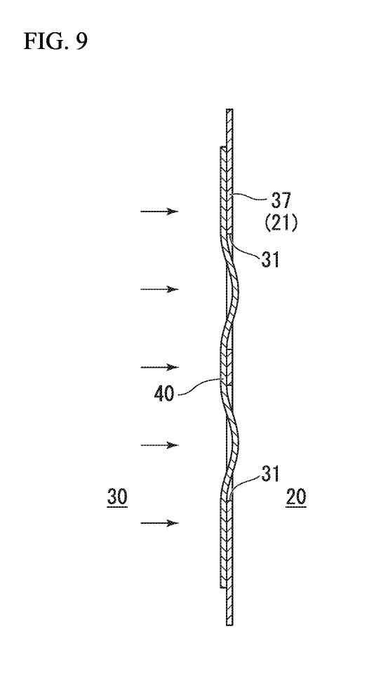

FIG. 8 and FIG. 9 are cross-sectional views in a VIII-VIII line of FIG. 7.

When an impact is input to the vehicle 1, the inflator 13 generates a high-pressure gas. When the gas is generated from the inflator 13, the main bag part 20 is supplied with the gas and is inflated and expanded.

When the gas is supplied to the inside of the main bag part 20, the pair of supplementary bag parts 30 is supplied with the gas via the plurality of communicating parts 31 from the inside of the main bag part 20 and is inflated and expanded. At this time, as shown in FIG. 8, the gas that flows into the inside of the supplementary bag part 30 from the inside of the main bag part 20 pushes the sheet member 40 and separates the sheet member 40 from the portion between the plurality of communicating parts 31 in the inner surface of the supplementary bag part 30. Thereby, a gap 43 is formed between the inner surface of the supplementary bag part 30 and the sheet member 40, and the gas is smoothly supplied from the inside of the main bag part 20 through the communicating part 31 and the gap 43 to the inside of the supplementary bag part 30.

When the occupant is moved frontward and comes into contact with the supplementary bag part 30, the pressure of the inside of the supplementary bag part 30 is increased. When the pressure of the inside of the supplementary bag part 30 is increased, a flow of the gas from the inside of the supplementary bag part 30 toward the inside of the main bag part 20 is generated in the vicinity of the communicating part 31 in the inside of the supplementary bag part 30. Then, as shown in FIG. 9, the sheet member 40 is moved toward the communicating part 31 and comes into close contact with the inner surface of the supplementary bag part 30 so as to close the communicating part 31. Thereby, the flowing of the gas out of the inside of the supplementary bag part 30 is prevented, and the inner pressure of the supplementary bag part 30 is maintained. As a result, the supplementary bag part 30 can receive the occupant while maintaining the shape that is inflated and expanded. At this time, the gas inside the main bag part 20 is discharged to the outside through the vent hole 25 (refer to FIG. 5).

In this way, the air bag apparatus 10 of the present embodiment includes the sheet member 40 that is fixed to the inner surface of the supplementary bag part 30, that covers the entirety of the plurality of communicating parts 31, and that is formed to be capable of approaching and being separated from a portion between the plurality of communicating parts 31 in the inner surface of the supplementary bag part 30.

According to this configuration, since the sheet member 40 covers the entirety of the plurality of communicating parts 31, when the inner pressure of the supplementary bag part 30 is increased, the sheet member 40 is pulled toward the main bag part 20 side at each of the plurality of communicating parts 31. Thereby, since portions of the sheet member 40 that correspond to portions between the adjacent communicating parts 31 are pulled in an opposite direction to each other, it is possible to prevent the sheet member 40 from being displaced along the inner surface of the supplementary bag part 30 and entering the communicating part 31. Accordingly, it is possible to prevent a gap from being generated at the communicating part 31 and to prevent the gas from flowing back to the main bag part 20.

Further, since the sheet member 40 is capable of approaching and being separated from the portion between the plurality of communicating parts 31 in the inner surface of the supplementary bag part 30, when the gas flows into the supplementary bag part 30 from the main bag part 20, the gap 43 between the inner surface of the supplementary bag part 30 and the sheet member 40 is formed to be large compared to a configuration in which the sheet member 40 is sewn to a part between the plurality of communicating parts 31 in the inner surface of the supplementary bag part 30 as in the related art. Thereby, it is possible to smoothly supply the gas to the supplementary bag part 30.

Accordingly, it is possible to promptly inflate and expand the supplementary bag part 30, and it is possible to maintain the inner pressure of the supplementary bag part 30 that is inflated and expanded.

Further, the minimal distance between the pair of fixation parts 41 in the sheet member 40 is larger than the spacing between the pair of fixation parts 41 in the inner surface of the supplementary bag part 30, and therefore, the sheet member 40 is arranged between the pair of fixation parts 41 in a slack state. Thereby, when the gas flows into the supplementary bag part 30 from the main bag part 20, it is possible to provide the gap 43 between the inner surface of the supplementary bag part 30 and the sheet member 40 so as to be further large. Accordingly, it is possible to further smoothly supply the gas to the supplementary bag part 30.

Further, as described above, when the inner pressure of the supplementary bag part 30 is increased, since the displacement of the sheet member 40 along the inner surface of the supplementary bag part 30 is prevented, even when the degree of freedom of the movement of the sheet member 40 is increased by the sheet member 40 being slack, the entering of the sheet member 40 into the communicating part 31 is prevented. Accordingly, it is possible to prevent a gap from being generated at the communicating part 31 and prevent the gas from flowing back to the main bag part 20.

Further, each of the pair of fixation parts 41 is provided on each of both sides in the second direction of the communicating part 31, and therefore, the sheet member 40 is pulled in the first direction that is orthogonal to the direction in which the pair of fixation parts 41 is arranged side by side with respect to the inner surface of the supplementary bag part 30 when the gas flows back. Further, since the plurality of communicating parts 31 are arranged side by side in the first direction, the number of each of communicating parts 31 close to each of end edges in the first direction of the sheet member 40 is one.

Thereby, even when the sheet member 40 is pulled and displaced in the first direction at the time of the gas flowing back, each of the end edge in the first direction of the sheet member 40 merely approaches one of the communicating parts 31. Accordingly, compared to a configuration in which each of the pair of fixation parts is provided on each of both sides in the first direction of the communicating part 31, it is possible to prevent the end edge of the sheet member 40 from entering the communicating part 31, and it is possible to prevent a gap from being formed at the communicating part 31.

Further, in a case where the predetermined region having a rectangular shape in the inner surface of the supplementary bag part 30 is covered by the sheet member, the sheet member is fixed along the long side of the predetermined region, and thereby, it is possible to make it difficult for the sheet member to be displaced compared to a case where the sheet member is fixed along the short side of the predetermined region.

According to the present embodiment, since the pair of fixation parts 41 extends along the first direction in which the plurality of communicating parts 31 are arranged side by side, and the size in the first direction of the pair of fixation parts 41 is larger than the spacing between the pair of fixation parts 41, the sheet member 40 becomes a state of being fixed along the long side of the region described above having a rectangular shape. Thereby, it is possible to make it difficult for the sheet member 40 to be displaced compared to a case where the pair of fixation parts extends along the first direction, and the size in the first direction of the pair of fixation parts is smaller than the spacing between the pair of fixation parts. Accordingly, it is possible to further reliably prevent the end edge of the sheet member 40 from entering the communicating part 31 and prevent a gap from being formed at the communicating part 31.

Further, the portion which is part of the seam line L where the main bag part 20 and one of the supplementary bag parts 30 are fixed and which is opposed in the right-to-left direction to another of the supplementary bag parts 30 is recessed when seen from the front-to-rear direction so as to be separated from another of the supplementary bag parts 30. Thereby, compared to a configuration in which the seam line extends linearly along the vertical direction when seen from the front-to-rear direction, it is possible to make it easier for the head part of the occupant to enter the space between the right and left seam lines L, and it is possible to regulate the displacement of the head of the occupant.

The present invention is not limited to the above embodiment described with reference to the drawings, and a variety of changes are conceivable within the technical scope of the invention.

For example, a pair of the communicating parts 31 is provided in the embodiment described above; however, the embodiment is not limited thereto. For example, three or more communicating parts may be provided. Further, it is not necessary to arrange all of the communicating parts on a straight line.

Further, in the embodiment described above, the communicating part 31 is formed in a circular hole shape; however, the embodiment is not limited thereto. For example, the communicating part 31 may be formed in a rectangular hole shape.

Further, in the embodiment described above, the supplementary bag part 30 is connected to the main bag part 20 by seaming; however, the embodiment is not limited thereto. For example, the supplementary bag part 30 may be connected to the main bag part 20 by thermocompression bonding, adhesion, and the like.

Further, in the embodiment described above, the partition wall part 37 is formed of the foundation cloth 21 that forms the main bag part 20; however, the embodiment is not limited thereto. For example, the partition wall part may be formed by overlapping the foundation cloth 21 of the main bag part 20 with the foundation cloth that forms the supplementary bag part.

Further, in the embodiment described above, the pair of fixation parts 41 is formed on the seam line L; however, the pair of fixation parts 41 may be provided at a position that is different from the seam line L.

Further, in the embodiment described above, the sheet member 40 is provided in a slack state; however, the embodiment is not limited thereto. The sheet member may be provided in a state where the sheet member has no slack.

Further, in the embodiment described above, the sheet member 40 is formed of the same material as the foundation cloth 21; however, the embodiment is not limited thereto. The sheet member may be formed of, for example, a material having stretch properties and may be formed such that the sheet member is pressed by the gas to extend when the gas flows into the inside of the supplementary bag part 30 from the inside of the main bag part 20 and is slack with respect to the inner surface of the supplementary bag part 30.

Further, in the embodiment described above, the sheet member 40 covers the whole of all of the communicating parts 31 when seen from the direction that is orthogonal to the first direction and the second direction; however, the embodiment is not limited thereto. The sheet member 40 may cover at least part of each communicating part 31. That is, the sheet member may be arranged so as to cover part of each of all of the communicating parts 31. Further, the sheet member may be arranged so as to cover the whole of communicating parts 31 which is part of the plurality of the communicating parts 31 and so as to cover part of the rest of the communicating parts 31. In any of these cases, when the inner pressure of the supplementary bag part 30 is increased, it is possible to prevent a gap which is larger than a designed gap from being generated at the communicating part 31 and to prevent the gas from flowing back to the main bag part 20 more than expected.

The configuration elements in the embodiment described above can be arbitrarily replaced by known configuration elements without departing from the scope of the invention.

What is claimed is:

1. An air bag apparatus, comprising:
an inflator that generates a gas when an impact is input;
a main bag part that is supplied with the gas from the inflator and is inflated and expanded;
a supplementary bag part that is connected to the main bag part and that is supplied with the gas via a plurality of communicating parts from an inside of the main bag part and is inflated and expanded; and
a sheet member that is fixed to an inner surface of the supplementary bag part, that covers entirety of the plurality of communicating parts, and that is formed to be capable of approaching and being separated from a portion between the plurality of communicating parts in the inner surface of the supplementary bag part.

2. The air bag apparatus according to claim 1, comprising
a pair of fixation parts to which the sheet member and an inner surface of the supplementary bag part are fixed,
wherein the plurality of communicating parts are provided between the pair of fixation parts in the inner surface of the supplementary bag part, and
a minimal distance between the pair of fixation parts in the sheet member is larger than a spacing between the pair of fixation parts in the inner surface of the supplementary bag part.

3. The air bag apparatus according to claim 1, comprising
a pair of fixation parts to which the sheet member and an inner surface of the supplementary bag part are fixed,
wherein the plurality of communicating parts are provided side by side in a first direction, and
each of the pair of fixation parts is provided on each of both sides in a second direction that is orthogonal to the first direction of the communicating part.

4. The air bag apparatus according to claim 2, comprising
a pair of fixation parts to which the sheet member and an inner surface of the supplementary bag part are fixed,
wherein the plurality of communicating parts are provided side by side in a first direction, and
each of the pair of fixation parts is provided on each of both sides in a second direction that is orthogonal to the first direction of the communicating part.

5. The air bag apparatus according to claim 3,
wherein the pair of fixation parts extends along the first direction, and
a size in the first direction of the pair of fixation parts is larger than a spacing between the pair of fixation parts.

6. The air bag apparatus according to claim 4,
wherein the pair of fixation parts extends along the first direction, and
a size in the first direction of the pair of fixation parts is larger than a spacing between the pair of fixation parts.
